(19) United States
(12) Patent Application Publication
(10) Pub. No.: US 2006/0168986 A1
(43) Pub. Date: Aug. 3, 2006

(54) Beverage supply device

(75) Inventors: Kazuhide Saitoh, Fukaya-shi (JP); Yuya Otsuka, Gunma-ken (JP); Takeo Igarashi, Kumagaya-shi (JP); Naoyuki Shiraishi, Saltama-shi (JP); Akira Goitsuka, Kounosu-shi (JP); Masahiro Kamiyama, Saitama-ken (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: SANYO ELECTRIC CO., LTD., Moriguchi-shi (JP)

(21) Appl. No.: 11/344,004

(22) Filed: Feb. 1, 2006

(30) Foreign Application Priority Data
Feb. 2, 2005 (JP) 26453/2005

(51) Int. Cl. B67D 5/62

(52) U.S. Cl. 62/390; 62/396

(57) ABSTRACT

An object is to provide a beverage supply device which can cool cooling water in a water tank provided with a beverage cooling pipe by use of a cooling unit using a refrigerant having little influence on global environment, a beverage dispenser is provided with the beverage cooling pipe (syrup cooling pipe, diluting water cooling pipe, carbonated water cooling pipe) disposed in the water tank to store cooling water, the water tank being cooled by an evaporation pipe, the beverage dispenser passes syrup, diluting water, and carbonated water as beverage ingredients through the beverage cooling pipe to extract beverage, and the beverage dispenser comprises: a cooling unit in which a compressor, a radiator, a capillary tube, the evaporation pipe and the like are connected to one another via a pipe to constitute a refrigerant circuit and which is filled with carbon dioxide as the refrigerant.

### BACKGROUND OF THE INVENTION

The present invention relates to a beverage supply device where a beverage cooling pipe is disposed in a water tank which stores cooling water and is cooled by a cooling unit, and a beverage or a beverage ingredient is passed through the beverage cooling pipe and extracted.

Heretofore, as described in Japanese Patent Application Laid-Open No. 6-336291, a beverage supply device for cooling and supplying a beverage ingredient such as syrup or a beverage such as cooling water or beer has a constitution in which cooling water is stored in a water tank. The water tank is cooled by an evaporation pipe of a cooling unit to generate ice around the tank. A beverage cooling pipe is disposed in a coiled form in such water tank, and the beverage ingredient or the like is extracted through this beverage cooling pipe to thereby momentarily cool and supply the beverage ingredient.

In the conventional beverage supply device, a refrigerant for use in the cooling unit is an HFC refrigerant which has been popular these days. However, such refrigerant is regarded as a cause for destroying an ozone layer, and there has been a demand for development of a refrigerant circuit using a refrigerant which has little influence on global environment from a viewpoint of protecting the global environment.

### SUMMARY OF THE INVENTION

The present invention has been developed to solve conventional technical problems, and there is provided a beverage supply device in which it is possible to cool cooling water in a water tank provided with a beverage cooling pipe by a cooling unit using a refrigerant which has little influence on global environment.

In a first aspect of the present invention, a beverage supply device is provided with a beverage cooling pipe disposed in a water tank to store cooling water, the water tank being cooled by a cooler, and the beverage supply device passes a beverage or a beverage ingredient through the beverage cooling pipe to extract the beverage or the beverage ingredient. The beverage supply device comprises a cooling unit in which a compressor, a radiator, pressure reducing means, the cooler and the like are connected to one another via a pipe to constitute a refrigerant circuit and which is filled with carbon dioxide as a refrigerant.

Moreover, in a second aspect of the present invention, the beverage supply device of the above-described invention further comprises: load detecting means for detecting a load on the compressor; and control means for controlling a rotational frequency of the compressor based on an output of the load detecting means.

Furthermore, in a third aspect of the present invention, the beverage supply device of the above-described invention further comprises: a blower which air-cools the radiator, and the control means controls a fed air amount of the blower based on an output of the load detecting means.

Additionally, in a fourth aspect of the present invention, in the beverage supply device of the second or third aspect of the present invention, the load detecting means is temperature detecting means for detecting a temperature of the radiator.

Moreover, in a fifth aspect of the present invention, in the beverage supply device of the second or third aspect of the present invention, the load detecting means is temperature detecting means for detecting a temperature of the cooling water in the water tank.

Furthermore, in a sixth aspect of the present invention, in the beverage supply device of the second or third aspect of the present invention, the load detecting means is temperature detecting means for detecting an outside air temperature.

Additionally, in a seventh aspect of the present invention, in the beverage supply device of the second or third aspect of the present invention, the load detecting means is current detecting means for detecting an energizing current of the compressor.

Moreover, in an eighth aspect of the present invention, in the beverage supply device of the second or third aspect of the present invention, the load detecting means is pressure detecting means for detecting a pressure in the refrigerant circuit.

Furthermore, in a ninth aspect of the present invention, in the beverage supply device of the fourth, fifth, sixth, seventh, or eighth aspect of the present invention, the control means lowers the rotational frequency of the compressor and/or increases the fed air amount of the blower in a case where the temperature detected by the temperature detecting means, a current value detected by the current detecting means, or the pressure detected by the pressure detecting means rises.

According to the first aspect of the present invention, the beverage supply device is provided with the beverage cooling pipe disposed in the water tank to store cooling water, the water tank being cooled by the cooler, and the beverage supply device passes the beverage or the beverage ingredient through the beverage cooling pipe to extract the beverage or the beverage ingredient. The beverage supply device comprises: the cooling unit in which the compressor, the radiator, the pressure reducing means, the evaporator and the like are connected to one another via the pipe to constitute the refrigerant circuit and which is filled with carbon dioxide as the refrigerant. Consequently, it is possible to cool the beverage cooling pipe disposed in the water tank without using any target refrigerant of control of chlorofluorocarbon as in a conventional art.

Since carbon dioxide for use as the refrigerant has non-flammable and non-corrosive properties, does not destroy ozone, and has a global warming coefficient which is 1/1000 or less of that of a chlorofluorocarbon-based refrigerant, it is possible to provide a beverage supply device suitable for environment, that is, a device which realizes non-chlorofluorocarbon. Since carbon dioxide is much more easily obtained as compared with another refrigerant, convenience is improved.

Moreover, according to the second aspect of the present invention, the device further comprises: the load detecting means for detecting the load on the compressor; and the control means for controlling the rotational frequency of the compressor based on the output of the load detecting means. Consequently, it is possible to avoid in advance a disadvantage that the compressor is brought into an overload operation.

That is, even in a case where carbon dioxide having a low critical temperature is used as the refrigerant as in the above-described invention, when the load of the compressor is detected by the load detecting means, it is possible to avoid in advance disadvantages that a pressure of the refrigerant circuit on a high-pressure side increases and that a refrigerant circulated amount decreases. Accordingly, it is possible to avoid deterioration of a freezing capability in advance. In consequence, an operation efficiency of the compressor can be set to be appropriate, and a cooling efficiency can be improved.

Moreover, the overload operation of the compressor can be avoided to prevent a disadvantage that the compressor stops by an operation of a safety system.

Furthermore, in the third aspect of the present invention, the device of the above-described invention further comprises: the blower which air-cools the radiator, and the control means controls the fed air amount of the blower based on the output of the load detecting means. Consequently, even in a case where the pressure of the refrigerant circuit on the high-pressure side increases, when the fed air amount of the blower for the radiator is increased, the air-cooling of the radiator can be promoted. In consequence, the overload operation of the compressor can further be inhibited.

Additionally, in the fourth aspect of the present invention, the load detecting means is constituted of the temperature detecting means for detecting the temperature of the radiator. Consequently, as in the ninth aspect of the present invention, the rotational frequency of the compressor can be lowered to thereby avoid in advance the overload operation of the compressor in a case where the temperature detected by the temperature detecting means rises. Moreover, in this case, when the fed air amount of the blower is increased, the air-cooling of the radiator can further be promoted, and the overload operation of the compressor can be effectively inhibited.

Moreover, in the fifth aspect of the present invention, the load detecting means is constituted of the temperature detecting means for detecting the temperature of the cooling water in the water tank. Consequently, as in the ninth aspect of the present invention, the rotational frequency of the compressor can be lowered to thereby avoid in advance the overload operation of the compressor in a case where the temperature detected by the temperature detecting means rises. Moreover, in this case, when the fed air amount of the blower is increased, the air-cooling of the radiator can further be promoted, and the overload operation of the compressor can be effectively inhibited.

Furthermore, in the sixth aspect of the present invention, the load detecting means is constituted of the temperature detecting means for detecting the outside air temperature. Consequently, as in the ninth aspect of the present invention, the rotational frequency of the compressor can be lowered to thereby avoid in advance the overload operation of the compressor in a case where the temperature detected by the temperature detecting means rises. Moreover, in this case, when the fed air amount of the blower is increased, the air-cooling of the radiator can further be promoted, and the overload operation of the compressor can be effectively inhibited.

Additionally, in the seventh aspect of the present invention, the load detecting means is constituted of the current detecting means for detecting the energizing current of the compressor. Consequently, as in the ninth aspect of the present invention, the rotational frequency of the compressor can be lowered to thereby avoid in advance the overload operation of the compressor in a case where the current value detected by the current detecting means rises. Moreover, in this case, when the fed air amount of the blower is increased, the air-cooling of the radiator can further be promoted, and the overload operation of the compressor can be effectively inhibited.

Moreover, in the eighth aspect of the present invention, the load detecting means is constituted of the pressure detecting means for detecting the pressure in the refrigerant circuit. Consequently, as in the ninth aspect of the present invention, the rotational frequency of the compressor can be lowered to thereby avoid in advance the overload operation of the compressor in a case where the pressure detected by the pressure detecting means rises. Moreover, in this case, when the fed air amount of the blower is increased, the air-cooling of the radiator can further be promoted, and the overload operation of the compressor can be effectively inhibited.

### BRIEF DESCRIPTION OF THE DRAWINGS

FIG. 1 is a front view of a beverage dispenser which utilizes the present invention;

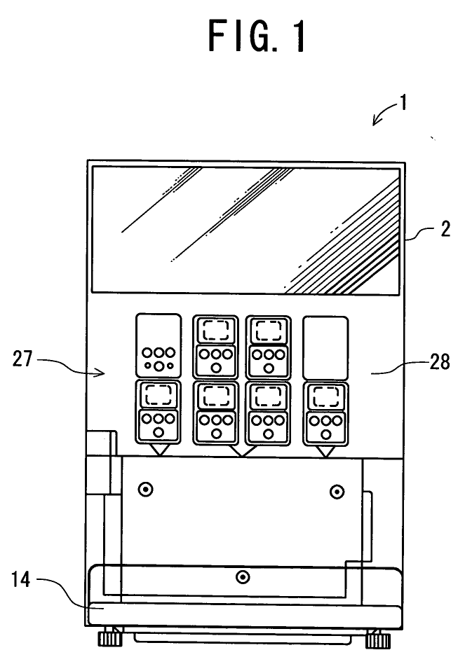

FIG. 2 is a side view of the beverage dispenser;

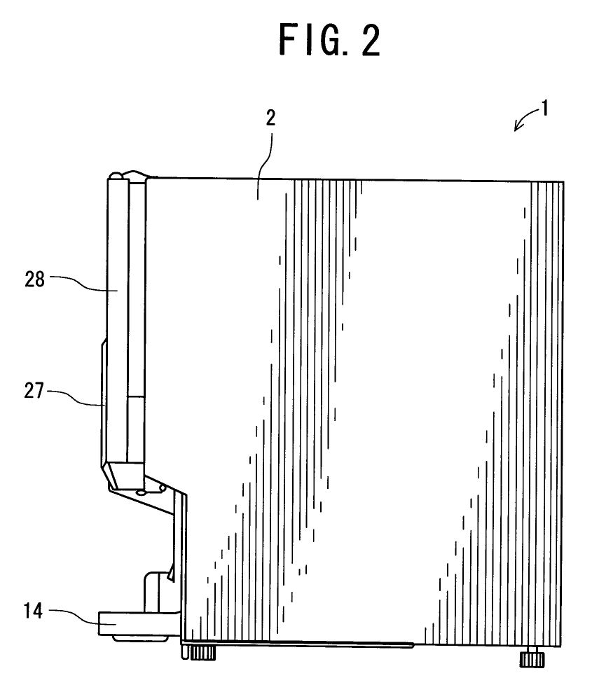

FIG. 3 is a schematic constitution diagram of the beverage dispenser;

FIG. 4 is a schematic constitution diagram showing a water tank and a cooling unit; and

FIG. 5 is a schematic constitution diagram of the cooling unit.

### DETAILED DESCRIPTION OF THE PREFERRED EMBODIMENT

### Embodiment 1

In a first embodiment, a beverage dispenser 1 is a beverage dispenser for use in a restaurant, a coffee shop or the like, and is a device provided with: a BIB unit (not shown) which supplies neutral beverages such as oolong tea and orange juice; and a tank unit 4 which similarly supplies strongly and lightly carbonated and uncarbonated target beverages. Such beverage dispenser 1 has a structure in which the BIB unit is disposed in a main body 2, and the tank unit 4 is externally connected to the main body. Moreover, the BIB unit is shielded behind an openably closed door 28 positioned in a front face of the main body. It is to be noted that the tank unit 4 will be described later in detail.

The front face of the opening/closing door 28 is provided with an operation section 27 which supplies the beverage from the tank unit 4 and the BIB unit. The section is provided with operation buttons such as buttons S, M, L, and C/P which select a beverage supply amount or a beverage supply method for each beverage to be supplied from each unit. The buttons S, M, and L are buttons for supplying a predetermined amount of beverage, and the button C/P is a button for supplying the beverage only while operated.

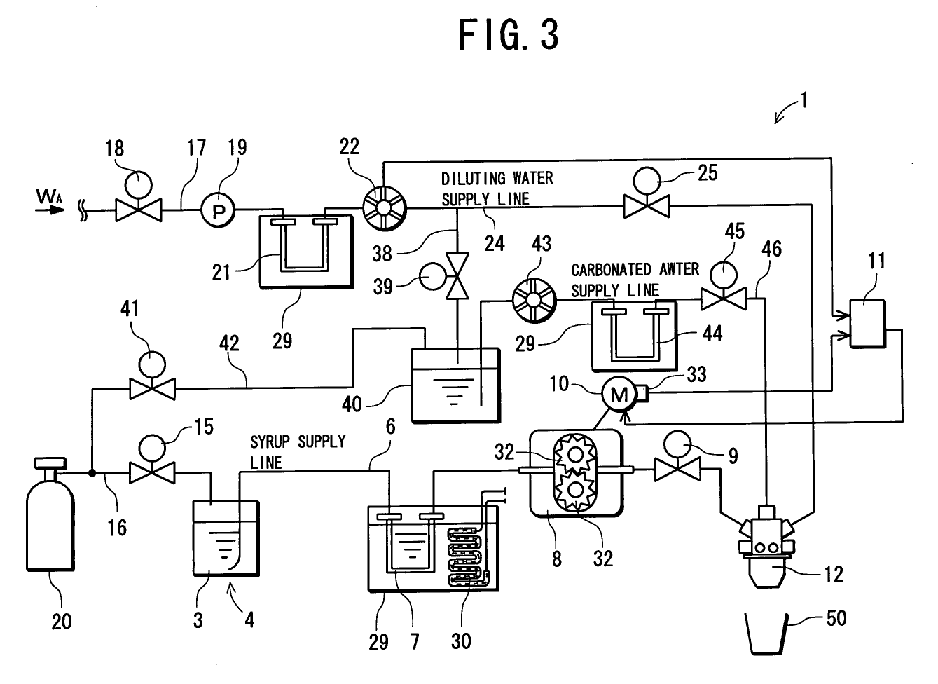

Furthermore, a multi-valve 12 (shown in FIG. 3 only) for discharging each beverage from the tank unit 4 is disposed in a lower rear part of this opening/closing door 28, and a table 14 is disposed under the nozzle 12 so that a cup is disposed on the table 14.

On the other hand, ingredients of the beverage supplied from the tank unit 4 include syrup as the beverage ingredient contained in a sealed container, for example, syrup (beverage ingredient) contained in a tank 3 and diluting water. In this case, when cooling water is used as diluting water, the uncarbonated beverage is supplied. When carbonated water is used, the strongly or lightly carbonated beverage is supplied. As shown in FIG. 3, the tank unit 4 is constituted by disposing: a syrup supply line 6 which supplies the syrup from the tank 3; a syrup cooling pipe (beverage cooling pipe) 7; a flow rate adjuster 8 driven by a driving motor 10; and a syrup electromagnetic valve 9. An end portion of this syrup supply line 6 is connected to the other supply lines, that is, a cooling water supply line 24 and a carbonated water supply line 46 together with the multi-valve 12. This multi-valve 12 mixes the syrup with diluting water or carbonated water to discharge the target beverage into a cup 50.

The tank 3 is connected to a carbon dioxide gas bomb 20 via a gas supply line 16 provided with a gas regulator 15. Accordingly, the gas regulator 15 as a pressure reducing valve is always opened. Therefore, when the syrup electromagnetic valve 9 positioned on a downstream side of the syrup supply line 6 is opened, the carbon dioxide gas having a predetermined pressure is supplied from the carbon dioxide gas bomb 20 to feed the syrup to the syrup supply line 6.

The syrup cooling pipe 7 is immersed into a water tank 29 which stores cooling water cooled by a cooling unit R described later in detail to thereby cool the syrup flowing through the pipe 7.

The flow rate adjuster 8 continuously feeds a certain volume of syrup to the syrup supply line 6 by means of a pair of rotors 32, 32 stored in the adjuster. A shaft of one of the rotors 32 is connected to the driving motor 10, and this motor 10 is provided with a magnet encoder 33 which generates a pulse having a frequency depending on a rotation speed of the motor 10.

Moreover, the energizing of the rotor driving motor 10 by the syrup electromagnetic valve 9 and the flow rate adjuster 8 is controlled by a control unit 11 described later. Accordingly, the syrup is fed from the tank 3 to the multi-valve 12 connected to the end portion of the syrup supply line 6, and the supplying of the syrup is controlled.

On the other hand, in the main body 2, there is disposed a diluting water supply pipe 17 which supplies tap water such as city water as diluting water. This diluting water supply pipe 17 is successively connected to a water inlet electromagnetic valve 18, a water pump 19, a diluting water cooling pipe (beverage cooling pipe) 21, a diluting water flow meter 22, and the diluting water supply line 24. It is to be noted that the diluting water cooling pipe 21 cools diluting water circulating in the diluting water cooling pipe 21 by means of cooling water cooled by the cooling unit R described later in detail in the same manner as in the syrup cooling pipe 7.

The diluting water flow meter 22 outputs a flow rate signal to the control unit 11 depending on a flow rate of inflowing diluting water. The diluting water supply line 24 is provided with a diluting water electromagnetic valve 25, so that opening/closing of the diluting water supply line 24 is controlled. It is to be noted that the diluting water supply line 24 is connected to the multi-valve 12 in the same manner as in the syrup supply line 6. Accordingly, the diluting water electromagnetic valve 25 is controlled by the control unit 11 to control the supplying of the diluting water to the multi-valve 12.

Moreover, the diluting water supply line 24 is connected to a water branch line 38 which is positioned between the diluting water flow meter 22 and the diluting water electromagnetic valve 25 and which is provided with an electromagnetic valve 39. This water branch line 38 is connected to a carbonator 40 for manufacturing carbonated water. Moreover, the carbonator 40 is connected to a gas supply line 42 whose one end is connected to the carbon dioxide gas bomb 20. The gas supply line 42 is provided with a gas regulator 41. Accordingly, diluting water is supplied to the carbonator 40 via the water branch line 38. Moreover, the carbon dioxide gas is supplied to the carbonator via the gas supply line 42, and diluting water is mixed with the carbon dioxide gas to generate carbonated water.

Furthermore, this carbonator 40 is connected to a carbonated water supply line 46 provided with a carbonated water flow meter 43, a carbonated water cooling pipe (beverage cooling pipe) 44, and a carbonated water electromagnetic valve 45, and an end portion of the carbonated water supply line 46 is connected to the multi-valve 12.

The carbonated water flow meter 43 outputs a flow rate signal to the control unit 11 depending on the flow rate of inflowing carbonated water. It is to be noted that the carbonated water cooling pipe 44 cools carbonated water circulating in the carbonated water cooling pipe 44 by means of cooling water cooled by the cooling unit R described later in detail in the same manner as in the syrup cooling pipe 7. The carbonated water electromagnetic valve 45 disposed on the carbonated water supply line 46 controls opening/closing of the carbonated water supply line 46. It is to be noted that the carbonated water supply line 46 is connected to the multi-valve 12 in the same manner as in the syrup supply line 6. Therefore, the carbonated water electromagnetic valve 45 is controlled by the control unit 11 to control the supplying of carbonated water to the multi-valve 12.

There will be described a beverage supplying operation of the beverage dispenser 1 constituted as described above. The carbon dioxide gas is supplied from the carbon dioxide gas bomb 20 to the carbonator 40 via the gas supply line 42 beforehand. It is also assumed that diluting water is supplied from the water branch line 38 to the carbonator via the diluting water supply line 24, carbonated water having a predetermined carbon dioxide concentration is manufactured and stored, and the device is brought into a standby state for dispensing.

When any of the operation buttons of the operation section 27 is operated in the standby state for the dispensing, the beverage is supplied in accordance with the button operation. Here, when the uncarbonated beverage button is operated, the control unit 11 opens the water inlet electromagnetic valve 18, and allows tap water supplied from city water via the water pump 19 to flow into the diluting water supply line 24 via the diluting water cooling pipe 21 and the diluting water flow meter 22. The control unit 11 controls the energizing of the rotor driving motor 10 which drives the syrup electromagnetic valve 9 and the flow rate adjuster 8, and accordingly allows the syrup supplied from the tank 3 to flow into the syrup supply line 6 via the syrup cooling pipe 7 and the flow rate adjuster 8. Accordingly, the syrup is diluted with diluting water at a predetermined ratio to generate a target beverage, and the beverage is supplied from the multi-valve 12 to the cup 50.

When the carbonated beverage button is operated, the control unit 11 opens the water inlet electromagnetic valve 18, and allows tap water supplied from city water via the water pump 19 to flow into the diluting water supply line 24 via the diluting water cooling pipe 21 and the diluting water flow meter 22. Furthermore, the opening/closing of the electromagnetic valve 39 and the carbonated water electromagnetic valve 45 is controlled to discharge a predetermined amount of carbonated water from the carbonator 40 to the multi-valve 12. Even in this case, when the predetermined amount of syrup is supplied to the syrup supply line 6 in the same manner as described above, the syrup is diluted with carbonated water at the predetermined ratio to generate the target beverage, and the beverage is supplied to the cup 50 via the multi-valve 12.

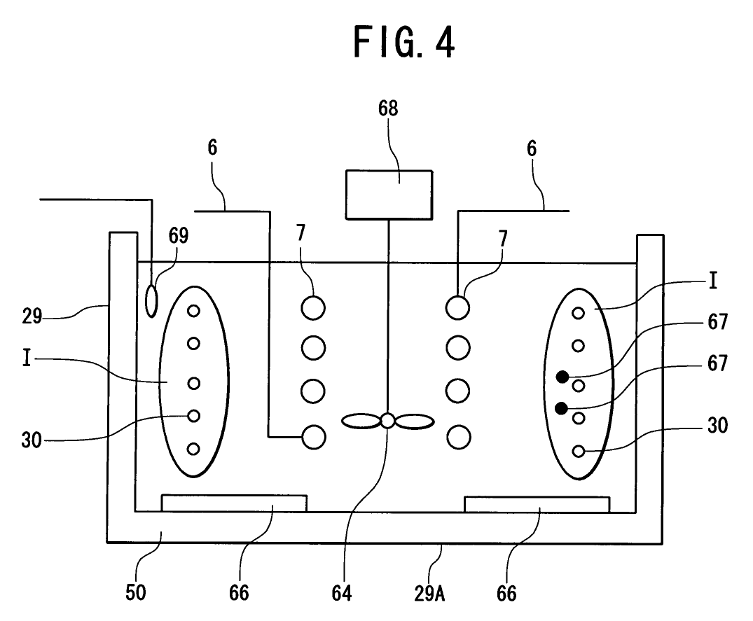

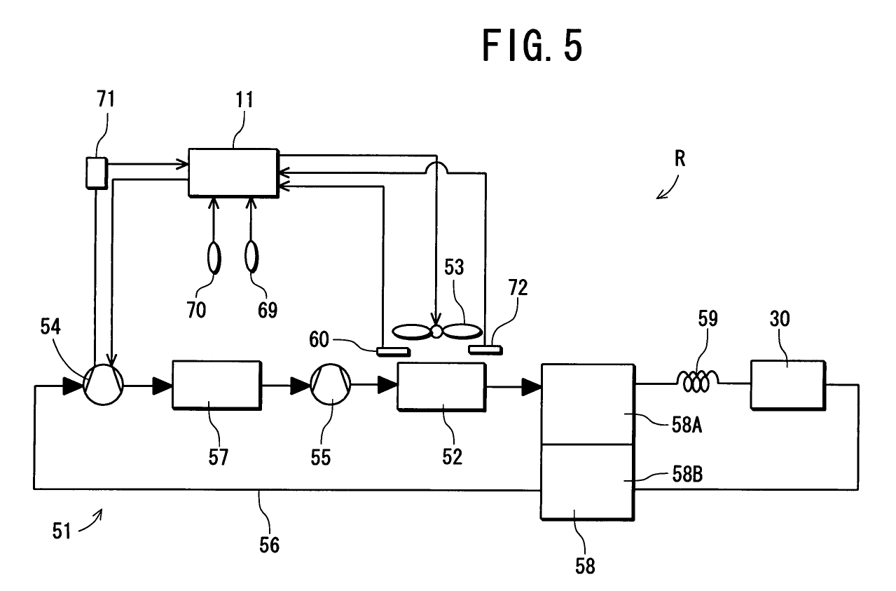

Next, there will be described a constitution of the water tank 29 and the cooling unit R with reference to FIGS. 4 and 5. The water tank 29 opens upwards, cooling water is stored in the tank, and an insulating wall 50 is disposed as a peripheral wall to insulate water. Under this water tank 29, there is disposed the cooling unit R constituted of a compressor 51, a radiator 52, a blower 53 for air-cooling the radiator 52 and the like.

As shown in FIG. 5, as the cooling unit R, there is used an intermediate inner pressure type multistage (two stages) compression type rotary compressor provided with an electromotive element (not shown) as the compressor 51, and first and second rotary compression elements 54, 55. As this compressor 51, an inverter system is adopted, and the rotational frequency of the compressor can be arbitrarily adjusted by means of the connected control unit 11.

Moreover, in the cooling unit R, there are successively connected via a refrigerant pipe 56: the first rotary compression element 54 of the compressor 51; an intermediate heat exchanger 57; the second rotary compression element 55 of the compressor 51; the radiator 52; a radiating section 58A of an inner heat exchanger 58; a capillary tube 59 as pressure reducing means; an evaporation pipe 30 as a cooler; and a heat absorbing section 58B of the inner heat exchanger 58. Accordingly, an annular freezing cycle is constituted.

Here, the radiating section 58A of the inner heat exchanger 58 exchanges heat with the cooling section 58B in which the refrigerant discharged from the evaporation pipe 30 circulates. The refrigerant circuit of this cooling unit R is filled with carbon dioxide as an eco-friendly natural refrigerant in consideration of flammability, toxicity and the like. The radiator 52 is provided with the blower 53 for ventilation. In FIG. 5, reference numeral 60 denotes a radiator temperature sensor (temperature detecting means as load detecting means) which detects a temperature of the radiator 52, and operations of the compressor 51 and the blower 53 are controlled based on an output of the radiator temperature sensor 60.

The evaporation pipe 30 constituting the freezing cycle of the cooling unit R together with the compressor 51 and the radiator 52 is inserted into the water tank 29 in a coiled state, and the pipe is immerged into cooling water of the water tank 29 to cool cooling water. On the other hand, the coiled beverage cooling pipes 7, 21, and 44 are inserted into the water tank 29 from above, and submerged in cooling water. It is to be noted that FIG. 4 shows the syrup cooling pipe 7 only, but it is assumed that the diluting water cooling pipe 21 and the carbonated water cooling pipe 44 are additionally inserted.

Moreover, an ice sensor 67 is disposed behind the evaporation pipes 30. This ice sensor 67 is constituted of two electrodes to detect an ice layer I around the evaporation pipe 30 from a change of a resistance value between the opposite electrodes. That is, when water is disposed between the electrodes, a low resistance value is indicated. When ice is disposed between them, a high resistance value is indicated. Therefore, the generation of the ice layer I is detected depending on such resistance value change.

A stirrer 64 is disposed in the water tank 29. The stirrer 64 is rotated by a motor 68. Four radially extending guide plates 66 are attached to the top of a bottom wall 29A of the water tank 29. The evaporation pipes 30 and lower end portions of the beverage cooling pipes 7 are held on upper edges of the guide plates 66, respectively.

There will be described an operation of the beverage supply device 1 of the present invention constituted as described above. When the beverage supply device 1 is installed, and power supply is turned on, the control unit 11 starts the compressor 51 of the cooling unit R to start the operation. When the electromotive element of the compressor 51 is energized, the element starts to rotate a rotors. This rotation allows upper and lower rollers (not shown) fitted into upper and lower eccentric portions (not shown) disposed integrally with a rotation shaft (not shown) to eccentrically rotate in upper and lower cylinders constituting the first and second rotary compression elements 54, 55. Accordingly, a low-pressure refrigerant gas sucked into the lower cylinder of the first rotary compression element 54 on the side of a low-pressure chamber is compressed by functions of the lower roller and vane to achieve an intermediate pressure. The gas is discharged from the lower cylinder on the high-pressure chamber side into the sealed container of the compressor 51. This brings the inside of the sealed container into the intermediate pressure.

Moreover, the intermediate-pressure refrigerant gas in the sealed container once flows out of the sealed container, and passes through the intermediate heat exchanger 57. The refrigerant is air-cooled in the exchanger, and in turn sucked into the upper cylinder of the second rotary compression element 55 in the sealed container. The gas is compressed in a second stage by functions of the upper roller and vane, and turns to a high-temperature high-pressure refrigerant gas. The gas is discharged from the high-pressure chamber side to the outside. In this case, the refrigerant has a temperature of about +86° C., and is compressed at an appropriate supercritical pressure.

In this case, as described above, the compressor 51 is an intermediate inner pressure type multistage (two stages) compression rotary compressor provided with the first and second rotary compression elements 54 and 55. That is, since the refrigerant sucked and compressed in the first rotary compression element 54 can be sucked and compressed by the second rotary compression element 55, it is possible to efficiently compress the carbon dioxide refrigerant under the supercritical pressure.

Furthermore, since the refrigerant discharged from the first rotary compression element 54 radiates heat by means of the intermediate heat exchanger 57, an amount of heat can be balanced. The intermediate heat exchanger 57 radiates heat from the refrigerant discharged from the first rotary compression element 54 so as to raise a density of refrigerant sucked into the second rotary compression element 55. A compression efficiency can thus be improved.

As described above, the refrigerant gas discharged from the compressor 51 flows into the radiator 52, and radiates heat by means of the ventilation by the blower 53. It is to be noted that in this case, the temperature of the radiator 52 is detected by the radiator temperature sensor 60. Based on the temperature, the rotational frequency of the compressor 51 is controlled, and the blower 53 is adjusted into a predetermined temperature.

Moreover, the refrigerant discharged from the radiator 52 flows into the radiating section 58A of the inner heat exchanger 58 to exchange heat with the heat absorbing section 58B disposed so as to exchange heat with the radiating section 58A. Accordingly, heat is taken to cool the refrigerant. It is to be noted that the refrigerant (carbon dioxide) compressed under the supercritical pressure is used in the cooling unit R of the present invention. Therefore, in the radiating section 58A, the refrigerant maintains its gas state without being liquefied, and the temperature drops.

The refrigerant gas on the high-pressure side is cooled in the radiating section 58A as described above, and reaches the capillary tube 59. The refrigerant gas still has the gas state in the inlet to the capillary tube 59, but turns to a two-phase mixture of gas and liquid owing to the pressure drop in the capillary tube 59. In this state, the refrigerant flows into the evaporation pipe 30. In the pipe, the refrigerant evaporates to cool cooling water in the water tank 29 by means of a heat absorbing function generated by the evaporation (in this case, the refrigerant has a temperature at about −5° C.).

The ice layer I is generated on an outer periphery of the evaporation pipe 30 during the cooling. When ice is generated between the electrodes of the ice sensor 67, the resistance value between the electrodes rises as described above. Therefore, the control unit 11 stops the compressor 51. Thereafter, when the ice between the electrodes melts, the resistance value between the electrodes lowers as described above. Therefore, the control unit 11 starts the compressor 51. The ice layer I having a certain thickness is generated around the evaporation pipe 30 under such control. Therefore, the beverage cooling pipes 7, 21, and 44 are cooled by latent heat of this ice layer I.

Moreover, the refrigerant discharged from the evaporation pipe 30 flows into the heat absorbing section 58B of the inner heat exchanger 58 to exchange heat with the radiating section 58A which is disposed so as to exchange heat with the heat absorbing section 58B. It is to be noted that the refrigerant exchanges heat with the cooling water or the radiating section 58A to achieve the gas state, and is again sucked into the first rotary compression element 54 of the compressor 51.

In the present invention, the refrigerant circuit of the cooling unit R is filled with carbon dioxide as the refrigerant. Since carbon dioxide is a substance which does not destroy ozone, non-chlorofluorocarbon can be realized, and a global warming coefficient can be set to 1/1000 or less of that of a chlorofluorocarbon-based refrigerant. Since carbon dioxide is much more easily obtained as compared with another refrigerant, convenience is improved.

Here, when the power supply is turned on, the control unit 11 sets the rotational frequency of the compressor 51 to, for example, 50 Hz, and the blower 53 of the radiator 52 is set to the usual rotational frequency to operate. On the other hand, in the present invention, carbon dioxide is used as the refrigerant of the refrigerant circuit of the cooling unit R. Therefore, since the critical temperature of carbon dioxide is low at about +31° C., the radiator 52 is sometimes brought into a supercritical pressure state in which the carbon dioxide refrigerant is not liquefied even if the refrigerant radiates heat at a usual outside air temperature. In this case, the pressure of the refrigerant circuit on the high-pressure side increases, a circulating refrigerant amount drops, and a freezing capability largely deteriorates. Therefore, the compressor 51 is brought into an overload operation state, and a freezing operation cycle is performed with a low efficiency.

Moreover, in the present embodiment, when the temperature detected by the radiator temperature sensor 60 is higher than, for example, +20° C. and lower than +40° C., the control unit 11 sets the rotational frequency of the compressor 51 to 50 Hz as described above, and the blower 53 of the radiator 52 is set to the usual rotational frequency, and operated. Moreover, when the temperature detected by the radiator temperature sensor 60 rises at, for example, +40° C. or more, the control unit 11 sets the rotational frequency of the compressor 51 down to, for example, 40 Hz, and sets the blower 53 to a predetermined high rotation-speed to operate the blower.

Consequently, the overload operation of the compressor 51 is judged in advance by the temperature of the radiator 52, and the rotational frequency of the compressor 51 is lowered. This inhibits a rise of the pressure of the refrigerant circuit on the high-pressure side, the compressor 51 can be operated in a stabilized state, and the operation can be realized with a good cooling efficiency. Therefore, it is possible to avoid a disadvantage that the pressure of the refrigerant circuit on the high-pressure side rises to increase power consumption. It is possible to avoid in advance a disadvantage that a safety system or the like operates to stop the operation, when the overload operation of the compressor 51 reaches its limitation.

Moreover, in this case, when the blower 53 is operated at a high speed with the temperature rise of the radiator 52, the air-cooling of the radiator 52 can be promoted, and the overload operation of the compressor 51 can further be inhibited.

It is to be noted that when the temperature detected by the radiator temperature sensor 60 drops at, for example, +20° C. or less, the control unit 11 raises the rotational frequency of the compressor 51 to 60 Hz, and ice can be quickly generated.

### Embodiment 2

There will be described hereinafter use of an outside air temperature sensor in load detecting means in a second embodiment. It is to be noted that a control unit 11 is connected to an outside air temperature sensor 70 as the load detecting means disposed in a main body 2 in order to detect an outside air temperature at which a beverage dispenser 1 is disposed as shown in FIG. 5.

When the temperature detected by the outside air temperature sensor 70 is higher than, for example, +10°C. and lower than +30° C. in such embodiment, the control unit 11 sets a rotational frequency of a compressor 51 to 50 Hz as described above, and sets the rotational frequency of a blower 53 of a radiator 52 to a usual rotational frequency to operate the blower. Moreover, when the temperature detected by the outside air temperature sensor 70 rises at, for example, +30° C. or more, the control unit 11 lowers the rotational frequency of the compressor 51 at 40 Hz, and operates the blower 53 at a predetermined high rotational frequency.

Consequently, when an overload operation of the compressor 51 is judged in advance by an outside air temperature, and the rotational frequency of the compressor 51 is lowered, a rise of pressure of a refrigerant circuit on a high-pressure side is inhibited, the compressor 51 can be operated in a stabilized state, and the operation can be realized with a good cooling efficiency. Even in this case, it is possible to avoid a disadvantage that the pressure of the refrigerant circuit on the high-pressure side rises to increase power consumption. It is possible to avoid in advance a disadvantage that a safety system or the like operates to stop the operation, when the overload operation of the compressor 51 reaches its limitation.

Even in this case, when the rotational frequency of the blower 53 is set to be high to operate the blower with the rise of the outside air temperature, air-cooling of the radiator 52 can be promoted, and the overload operation of the compressor 51 can further be inhibited.

It is to be noted that when the temperature detected by the outside air temperature sensor 70 drops at, for example, +10° C. or less, the control unit 11 raises the rotational frequency of the compressor 51 to 60 Hz, and ice can be generated quickly.

### Embodiment 3

There will be described hereinafter use of a cooling water temperature sensor in load detecting means in a third embodiment. In this case, a cooling water temperature sensor 69 is disposed in a water tank 29 in order to detect a temperature of pooled cooling water. It is assumed that the cooling water temperature sensor 69 is connected to a control unit 11.

When the temperature detected by the cooling water temperature sensor 69 is higher than, for example, +1° C. and lower than +5° C. in such embodiment, the control unit 11 sets a rotational frequency of a compressor 51 to 50 Hz as described above, and sets the rotational frequency of a blower 53 of a radiator 52 to a usual rotational frequency to operate the blower. Moreover, when the temperature detected by the cooling water temperature sensor 69 rises at, for example, +5° C. or more, the control unit 11 lowers the rotational frequency of the compressor 51 at 40 Hz, and operates the blower 53 at a predetermined high rotational frequency.

Even in this case, when an overload operation of the compressor 51 is judged in advance by the temperature of the cooling water of the water tank 29, and the rotational frequency of the compressor 51 is lowered, a rise of pressure of a refrigerant circuit on a high-pressure side is inhibited, the compressor 51 can be operated in a stabilized state, and the operation can be realized with a good cooling efficiency. Even in this case, it is possible to avoid a disadvantage that the pressure of the refrigerant circuit on the high-pressure side rises to increase power consumption. It is possible to avoid in advance a disadvantage that a safety system or the like operates to stop the operation, when the overload operation of the compressor 51 reaches its limitation.

Even in this case, when the rotational frequency of the blower 53 is set to be high to operate the blower with the temperature rise of the cooling water in the water tank 29, air-cooling of the radiator 52 can be promoted, and the overload operation of the compressor 51 can further be inhibited.

It is to be noted that when the temperature detected by the cooling water temperature sensor 69 drops at, for example, +1° C. or less, the control unit 11 raises the rotational frequency of the compressor 51 to 60 Hz, and ice can be generated quickly.

### Embodiment 4

There will be described hereinafter use of energizing current value detecting means of a compressor 51 in load detecting means in a fourth embodiment. In this case, a compressor 51 is provided with a current value detecting sensor 71 for detecting an energizing current value of the compressor 51 as shown in FIG. 5. It is assumed that the current value detecting sensor 71 is connected to a control unit 11.

When the energizing current value detected by the current value detecting sensor 71 is higher than a predetermined lower limit value and lower than an upper limit value in such embodiment, the control unit 11 sets a rotational frequency of a compressor 51 to 50 Hz as described above, and sets the rotational frequency of a blower 53 of a radiator 52 to a usual rotational frequency to operate the blower. Moreover, when the energizing current value detected by the current value detecting sensor 71 rises to the predetermined upper limit value, the control unit 11 lowers the rotational frequency of the compressor 51 at, for example, 40 Hz, and operates the blower 53 at a predetermined high rotational frequency.

Consequently, an overload operation of the compressor 51 can be judged directly by the energizing current value to the compressor 51. Therefore, the rotational frequency of the compressor 51 can be lowered to inhibit a rise of pressure of a refrigerant circuit on a high-pressure side, the compressor 51 can be operated in a stabilized state, and the operation can be realized with a good cooling efficiency. Even in this case, it is possible to avoid a disadvantage that the pressure of the refrigerant circuit on the high-pressure side rises to increase power consumption. It is possible to avoid in advance a disadvantage that a safety system or the like operates to stop the operation, when the overload operation of the compressor 51 reaches its limitation.

Even in this case, when the rotational frequency of the blower 53 is set to be high to operate the blower, air-cooling of the radiator 52 can be promoted, and the overload operation of the compressor 51 can further be inhibited.

It is to be noted that when the energizing current value detected by the current value detecting sensor 71 drops to a value that is not more than a predetermined lower limit value, the control unit 11 raises the rotational frequency of the compressor 51 to 60 Hz, and ice can be generated quickly.

### Embodiment 5

There will be described hereinafter a case where pressure detecting means for detecting a pressure in a refrigerant circuit is used in load detecting means in a fifth embodiment. In this case, a radiator 52 is provided with a pressure sensor 72 for detecting the pressure in the radiator 52 as shown in FIG. 5. It is assumed that the pressure sensor 72 is connected to a control unit 11.

When the pressure in the radiator 52 detected by the pressure sensor 72 is higher than a predetermined lower limit value and lower than an upper limit value in such embodiment, the control unit 11 sets a rotational frequency of a compressor 51 to 50 Hz as described above, and sets the rotational frequency of a blower 53 of a radiator 52 to a usual rotational frequency to operate the blower. Moreover, when the pressure detected by the pressure sensor 72 rises to the predetermined upper limit value, the control unit 11 lowers the rotational frequency of the compressor 51 to, for example, 40 Hz, and operates the blower 53 at a predetermined high rotational frequency.

Consequently, an overload operation of the compressor 51 can be judged by the pressure in the radiator 52. Therefore, the rotational frequency of the compressor 51 can be lowered to inhibit a rise of pressure of a refrigerant circuit on a high-pressure side, the compressor 51 can be operated in a stabilized state, and the operation can be realized with a good cooling efficiency. Even in this case, it is possible to avoid a disadvantage that the pressure of the refrigerant circuit on the high-pressure side rises to increase power consumption. It is possible to avoid in advance a disadvantage that a safety system or the like operates to stop the operation, when the overload operation of the compressor 51 reaches its limitation.

Even in this case, when the rotational frequency of the blower 53 is set to be high to operate the blower, air-cooling of the radiator 52 can be promoted, and the overload operation of the compressor 51 can further be inhibited.

It is to be noted that when the pressure detected by the pressure sensor 72 drops to a value that is not more than a predetermined lower limit value, the control unit 11 raises the rotational frequency of the compressor 51 to 60 Hz, and ice can be generated quickly.

It is to be noted that in the above-described embodiments, the present invention is applied to the beverage supply device which extracts various types of beverages such as juice, but the present invention is not limited to the device, and is effective even for a beverage supply device which extracts cold water or beer.

1. A beverage supply device where a beverage cooling pipe is disposed in a water tank which stores cooling water and is cooled by a cooler, and a beverage or a beverage ingredient is passed through the beverage cooling pipe and extracted, the beverage supply device comprising:
a cooling unit in which a compressor, a radiator, pressure reducing means, the cooler and the like are connected to one another via a pipe to constitute a refrigerant circuit and which is filled with carbon dioxide as a refrigerant.

2. The beverage supply device according to claim 1, further comprising:
load detecting means for detecting a load on the compressor; and
control means for controlling a rotational frequency of the compressor based on an output of the load detecting means.

3. The beverage supply device according to claim 2, further comprising:
a blower which air-cools the radiator,
the control means controlling a fed air amount of the blower based on an output of the load detecting means.

4. The beverage supply device according to claim 2, wherein the load detecting means is temperature detecting means for detecting a temperature of the radiator.

5. The beverage supply device according to claim 2, wherein the load detecting means is temperature detecting means for detecting a temperature of the cooling water in the water tank.

6. The beverage supply device according to claim 2, wherein the load detecting means is temperature detecting means for detecting an outside air temperature.

7. The beverage supply device according to claim 2, wherein the load detecting means is current detecting means for detecting an energizing current of the compressor.

8. The beverage supply device according to claim 2, wherein the load detecting means is pressure detecting means for detecting a pressure in the refrigerant circuit.

9. The beverage supply device according to claim 4, wherein the control means lowers the rotational frequency of the compressor and/or increases the fed air amount of the blower in a case where the temperature detected by the temperature detecting means, a current value detected by the current detecting means, or the pressure detected by the pressure detecting means rises.

10. The beverage supply device according to claim 3, wherein the load detecting means is temperature detecting means for detecting a temperature of the radiator.

11. The beverage supply device according to claim 3, wherein the load detecting means is temperature detecting means for detecting a temperature of the cooling water in the water tank.

12. The beverage supply device according to claim 3, wherein the load detecting means is temperature detecting means for detecting an outside air temperature.

13. The beverage supply device according to claim 3, wherein the load detecting means is current detecting means for detecting an energizing current of the compressor.

14. The beverage supply device according to claim 3, wherein the load detecting means is pressure detecting means for detecting a pressure in the refrigerant circuit.

15. The beverage supply device according to claim 5, wherein the control means lowers the rotational frequency of the compressor and/or increases the fed air amount of the blower in a case where the temperature detected by the temperature detecting means, a current value detected by the current detecting means, or the pressure detected by the pressure detecting means rises.

16. The beverage supply device according to claim 6, wherein the control means lowers the rotational frequency of the compressor and/or increases the fed air amount of the blower in a case where the temperature detected by the temperature detecting means, a current value detected by the current detecting means, or the pressure detected by the pressure detecting means rises.

17. The beverage supply device according to claim 7, wherein the control means lowers the rotational frequency of the compressor and/or increases the fed air amount of the blower in a case where the temperature detected by the temperature detecting means, a current value detected by the current detecting means, or the pressure detected by the pressure detecting means rises.

18. The beverage supply device according to claim 8, wherein the control means lowers the rotational frequency of the compressor and/or increases the fed air amount of the blower in a case where the temperature detected by the temperature detecting means, a current value detected by the current detecting means, or the pressure detected by the pressure detecting means rises.
